(19) United States
(12) Patent Application Publication
(10) Pub. No.: US 2018/0265052 A1
(43) Pub. Date: Sep. 20, 2018

(54) STABLIZER FOR TRAILERS AND RECREATIONAL VEHICLES

(71) Applicant: James Wyatt HOLES, Fruitport, MI (US)

(72) Inventor: James Wyatt HOLES, Fruitport, MI (US)

(21) Appl. No.: 15/879,162

(22) Filed: Jan. 24, 2018

Related U.S. Application Data
(60) Provisional application No. 62/471,240, filed on Mar. 14, 2017.

(51) Int. Cl. B60S 9/02; B62D 63/08

(52) U.S. Cl. CPC B60S 9/02; B60P 3/34; B62D 63/08

(57) ABSTRACT

Methods and systems of and for improving the lateral stabilization trailers and recreational vehicles. Methods and systems of and for preventing lateral movement or “side-to-side rocking” of a trailer or recreational vehicle includes laterally extending diagonal legs or struts connected and/or braced with a single chain or cable.

### CROSS REFERENCE TO RELATED APPLICATION

This application claims the benefit of the filing date of U.S. Provisional Patent Application Ser. No. 62/471,240 filed Mar. 14, 2017, entitled IMPROVED STABILIZER FOR TRAILERS AND RECREATIONAL VEHICLES, herein incorporated by reference in its entirety.

### FIELD OF THE INVENTION

The present invention relates to trailers and recreational vehicles. More specifically, the present invention relates to an improved method and system of preventing lateral movement or “side-to-side rocking” of a trailer or recreational vehicle. The invention includes affixed laterally extending diagonal legs or struts supported, bolstered, secured, tethered, connected with a single chain or cable.

### BACKGROUND OF THE INVENTION

Towed trailers and other recreational vehicles are typically and purposefully designed and manufactured to be of light-weight materials and construction. Primarily, this is done to provide for ease of towing and for fuel cost savings. A common configuration for such vehicles includes a single or dual axle suspension placed roughly at the center of a ridged frame which extends forward of the axle and terminating in a ball hitch or other type coupling mechanism.

Typically, dimensions of trailers or recreational vehicles are limited by the common widths of roadway vehicle lanes. Most highway or roadway lanes typically vary from 9 to 15 feet (3 to 5 m) in width and are commonly narrower on low-volume or low-speed roads, and wider on higher-volume or higher-speed roads. Typical lane widths also include a clearance to allow for lateral or side-to-side motion of the vehicle in travel.

Accordingly, the clear majority of trailers and recreational vehicles are longer than they are wide, and include a ridged frame or chassis on which is mounted a platform, containment walls and/or doors, recreational living quarters, or commercial, law enforcement, or military living and/or working quarters.

After being parked at a desired location, a trailer or vehicle may be and commonly is prepared for use by leveling. Such known leveling systems range in complexity from simple manual systems, such as adjustable jack-stands, to computer controlled automatic integrated systems utilizing electrical, hydraulic, or compressed-gas activation. Most known leveling systems include legs or struts perpendicular to the frame which extend below the trailer or vehicle. Some configurations for leveling include four adjustable struts placed near or about the “four corners” of the frame. Other configurations for towed or detachable trailers or vehicles include only two adjustable perpendicular legs or struts toward the front or connection point of the frame.

So called “two-leg levelers” are commonly used with towed or “fifth-wheel” trailers and recreational vehicles. Typically, simply placing a jack-stand or other support at a ball-hitch or other central point along the trailer or vehicle frame longitudinal axis is inherently unsafe; therefore, most if not all such trailers or recreational vehicles utilize a “two-leg” support system positioned toward the front and lateral or at outer edges of the frame.

Although such systems are typically adequate for leveling a trailer or vehicle, unwanted lateral movement or “side-to-side rocking” of the trailer or vehicle commonly occurs due to wind, the movement of persons inside a recreational living quarter, or commercial, law enforcement, or military working quarters, and the like.

Moreover, and very commonly, vehicles or trailers include fold-out or deployable stairs or steps which may and do extend laterally from the trailer or vehicle, in some designs extend laterally for several feet. As an adult, or more relevantly, an obese person who may weight several hundred pounds, utilizes the lowest and thus most distal stair the resulting lateral movement or rocking of the trailer or vehicle is usually quite pronounced.

In an attempt to mitigate or eliminate such unwanted rocking movement, known systems provide additional legs or struts which project laterally beyond and away from any existing perpendicular stabilizing or leveling legs or struts. Such known systems include scissors jacks, A-frame jacks, and/or telescoping bars which operate independently of an integrated leveling system.

However, all such known systems fail to solve the problem of diagonally configured lateral legs or struts flexing and/or sliding away from the trailer or vehicle, and thus allowing unwanted side-to-side rocking. To attempt to alleviate this inherent flexing or sliding of a diagonally configured lateral struts, known systems disadvantageously provide overly robust struts made of heavy and/or dense materials and components.

Moreover and disadvantageously, for two primary reasons, even such known ruggedized systems fail to prevent flexing of such struts, nor the movement of a strut at an attachment or fulcrum point.

First, known systems include proximal base plates or “foot-pads” which lack spikes or other protrusions which can penetrate the ground, thus attempting to prevent lateral sliding movement. Moreover, foot-pad spikes or protrusions are typically undesirable as they fail to penetrate hard surfaces such as concrete or asphalt; and are limited in effectiveness when used on soft soils and/or loose sand.

Secondly, known systems include additional and adjustable bracing arms to struts connected to a primary diagonal leg or strut to prevent lateral sliding movement. Such additional bracing is undesirable due to added weight and complexity of deployment and adjustment.

One known system is described in U.S. Pat. No. 5,575,492 to Stone, herein incorporated by reference in its entirety (hereinafter “Stone”). As depicted in PRIOR ART FIG. 1, Stone attempts to economically provide a trailer or recreational vehicle lateral stabilizer including two diagonally connected legs or struts (34 and 34′) braced or connected to two primary leveling legs or struts (28 and 28′) with two chains or cables (61 and 61′). However, this configuration is deficient in that a primary leveling leg or strut may and will flex due to the lateral tension of the chains or cables (61 and 61′).

Furthermore, in Stone, the device only works in the front travel trailers because in the rear uses scissor jacks. Stone is also deficient in that there is no pressure onto base plates 46 or 61 which means that it will only react when the trailer moves far enough to tighten the chain and make solid contact to the ground upon movement. Furthermore, electric jack 24 slides into upper portion 30 which means there is clearance built into them which also means movement. So, when the trailer rocks base plates 46 pads will just slide with the movement.

Additional known systems that are deficient include U.S. Pat. No. 7,249,754 to Garceau et al.; U.S. Pat. No. 6,494,487 to Nebel; U.S. Pat. No. 6,331,016 to Wallace et al.; U.S. Pat. No. 6,224,102 to Nebel; U.S. Pat. No. 6,102,438 to Few et al.; U.S. Pat. No. 5,988,594 to Gil; U.S. Pat. No. 5,901,980 to Few et al.; U.S. Pat. No. 5,501,428 to Garceau; U.S. Pat. No. 5,205,586 to Tallman; U.S. Pat. No. 5,042,779 to Eden; U.S. Pat. No. 4,103,869 to Mesny et al.; U.S. Pat. No. 3,760,906 to McGee; U.S. Pat. No. 3,656,778 to Bristol; U.S. Pat. No. 3,565,396 to Spear; U.S. Pat. No. 3,345,038 to Taylor; U.S. Pat. No. 2,358,488 to Black; and US20060081755 to Thorpe.

It is an object of the present invention to overcome the deficiencies in these prior art references.

### SUMMARY OF THE INVENTION

What is desired is to provide a method and system of and for stabilizing a stationary trailer or recreational vehicle which mitigates or prevents lateral “side-to-side rocking” movement, including the improvement of affixing at least two laterally opposing diagonally extending legs or struts to the trailer or vehicle, the legs or struts connected and/or braced with a single fixed or adjustable length chain or cable to exert equilateral tension between the legs or struts, and thereby consequently exert and maintain a downward force at the leg or strut ends when impacting a surface or the ground.

What is desired is to provide a method and system of and for stabilizing a stationary trailer or recreational vehicle which mitigates or prevents lateral “side-to-side rocking” movement, including at least two laterally opposing diagonally extending legs connected and/or braced with a single fixed or adjustable length chain or cable to exert equilateral tension between the legs or struts, and thereby consequently exert and maintain a downward force at the leg or strut ends when impacting a surface or the ground; the method and system capable of inherent adjustment of the chain or cable tension after a trailer or vehicle is leveled and the legs or struts are deployed on an uneven surface or uneven ground

To improve upon the prior art, an object of the present invention is to provide a method and system of and for stabilizing a stationary trailer or recreational vehicle which mitigates or prevents lateral “side-to-side rocking” movement, including the improvement of affixing at least two laterally opposing diagonally extending legs or struts to the trailer or vehicle, the legs or struts connected and/or braced with a single fixed or adjustable length chain or cable to exert equilateral tension between the legs or struts, and thereby consequently exert and maintain a downward force at the leg or strut ends when impacting a surface or the ground.

Another object of the present invention is to provide a method and system of and for stabilizing a stationary trailer or recreational vehicle which mitigates or prevents lateral “side-to-side rocking” movement, including at least two laterally opposing diagonally extending legs connected and/or braced with a single fixed or adjustable length chain or cable to exert equilateral tension between the legs or struts, and thereby consequently exert and maintain a downward force at the leg or strut ends when impacting a surface or the ground; the method and system capable of inherent adjustment of the chain or cable tension after a trailer or vehicle is leveled and the legs or struts are deployed on an uneven surface or uneven ground.

These and other objects of the invention are achieved by providing a system of and for stabilizing a recreational vehicle (RV), the system comprising: at least two laterally opposing diagonally extending legs or struts proximally affixed to the recreational vehicle frame; and a single chain or cable connecting the legs or struts; wherein when the legs or struts distally impact a surface and/or the ground the legs or struts transfer vector mechanical forces from the surface and/or the ground to the recreational vehicle frame to mitigate or prevent lateral rocking movement of the recreational vehicle.

In certain embodiments, the recreational vehicle is selected from a group consisting of a stationary trailer, trailer home, house trailer, static caravan, residential caravan, modular home, vehicle capable of being towed or on a trailer, and prefabricated structure.

In certain embodiments, the at least one of the at least two legs or struts includes a distally mounted foot pad.

In certain embodiments, the single chain or cable exerts equilateral tension on the legs or struts.

In certain embodiments, the at least two legs or struts are affixed to the recreational vehicle frame by mechanical systems from the group consisting of eye bolts, bushings, traversing openings with bolt and nut, ball and socket joints, and combinations thereof.

In certain embodiments, the single chain or cable length is adjustable and fixable.

In certain embodiments, the single chain or cable length is adjustable and fixable under tension.

In certain embodiments, the single chain or cable ends are connected at a distally mounted foot pad of at least one of the at least two legs or struts.

In certain embodiments, the single chain or cable ends are connected at the at least two leg or strut distal ends.

In certain embodiments, the at least two legs or struts are of differing lengths.

In certain embodiments, the at least two legs or struts are adjustable and fixable in length via mechanical systems from the group consisting of telescoping nested tubes secured by perpendicular traversing openings and pins, releasable threaded, tension, or friction collars, and combinations thereof.

In certain embodiments, the single chain or cable length is adjusted and fixed via mechanical systems from the group consisting of turnbuckles, come-alongs, manual-winches, electric-winches, and combinations thereof.

In certain embodiments, the system is capable of chain or cable tension adjustment after the legs or struts are deployed on an uneven surface or uneven ground.

In certain embodiments, the system includes at least four legs or struts.

In certain embodiments, the system is capable of being removed and/or stowed to allow for road worthy recreational vehicle movement and/or towing.

Other objects of the invention are achieved by providing a system of and for stabilizing a recreational vehicle, the system comprising: at least two laterally opposing diagonally extending legs or struts proximally affixed to the recreational vehicle chassis or frame, the legs or struts connected with a single chain or cable to exert tension between the legs or struts; wherein when the legs or struts distally impact a surface and/or the ground transfers to mitigate or prevent lateral rocking movement of the recreational vehicle.

Other objects of the invention are achieved by providing a method of and for stabilizing a stationary recreational vehicle, the method comprising: providing at least two laterally opposing diagonally extending legs or struts; affixing the proximal end of the at least two legs or struts to the recreational vehicle frame; providing a single chain or cable; and connecting the single chain or cable to the at least two legs or struts to exert equilateral tension between the at least two legs or struts; wherein when the legs or struts distally impact a surface and/or the ground the legs or struts transfer vector mechanical forces from the surface and/or the ground to the recreational vehicle frame to mitigate or prevent lateral rocking movement of the recreational vehicle.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a PRIOR ART diagram of a trailer stabilizing system.

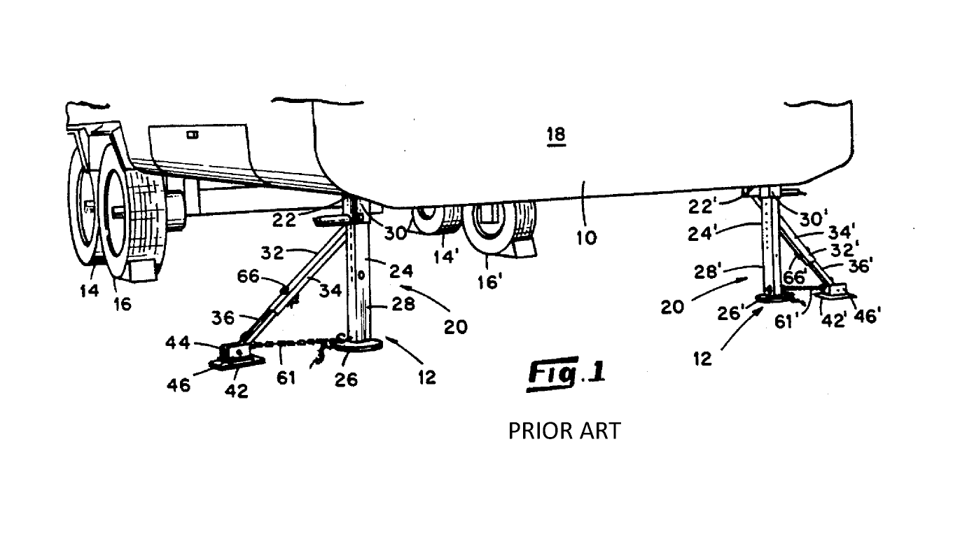

FIG. 2 is a schematic diagram of an embodiment of the inventive system and method depicting deployment on a level surface or ground.

FIG. 3 is a schematic diagram of an embodiment of the inventive system and method depicting deployment on a pronounced uneven surface or ground.

FIG. 4 is a perspective view of the system of an embodiment of the inventive system.

FIG. 5 is a perspective view of the system of an embodiment of the inventive system employed upon a recreational vehicle.

FIG. 6 is a perspective view of the system of an embodiment of the inventive system employed upon a recreational vehicle.

### DETAILED DESCRIPTION OF THE INVENTION

In the following description, numerous details are set forth for the purpose of explanation. However, one of ordinary skill in the art will realize that the invention may be practiced without the use of these specific details. For instance, the techniques described below are described in a specified order, but other embodiments may change the order of the operations while still embodying the current invention.

In certain embodiments, the inventive method and system comprises affixing two laterally opposing diagonally extending legs or struts to the trailer or vehicle.

In certain embodiments, the inventive method and system comprises affixing four laterally opposing diagonally extending legs or struts to the trailer or vehicle.

In certain embodiments, the inventive method and system comprises a single fixed or adjustable length chain or cable connected at or near the proximal ends of one pair of opposing legs or struts to exert equilateral tension between the legs or struts, and thereby consequently exert and maintain a downward force at the leg or strut ends when impacting a surface or the ground.

In certain embodiments, the inventive method and system is capable of inherent adjustment of the chain or cable tension after a trailer or vehicle is leveled and the legs or struts are deployed on an uneven surface or uneven ground.

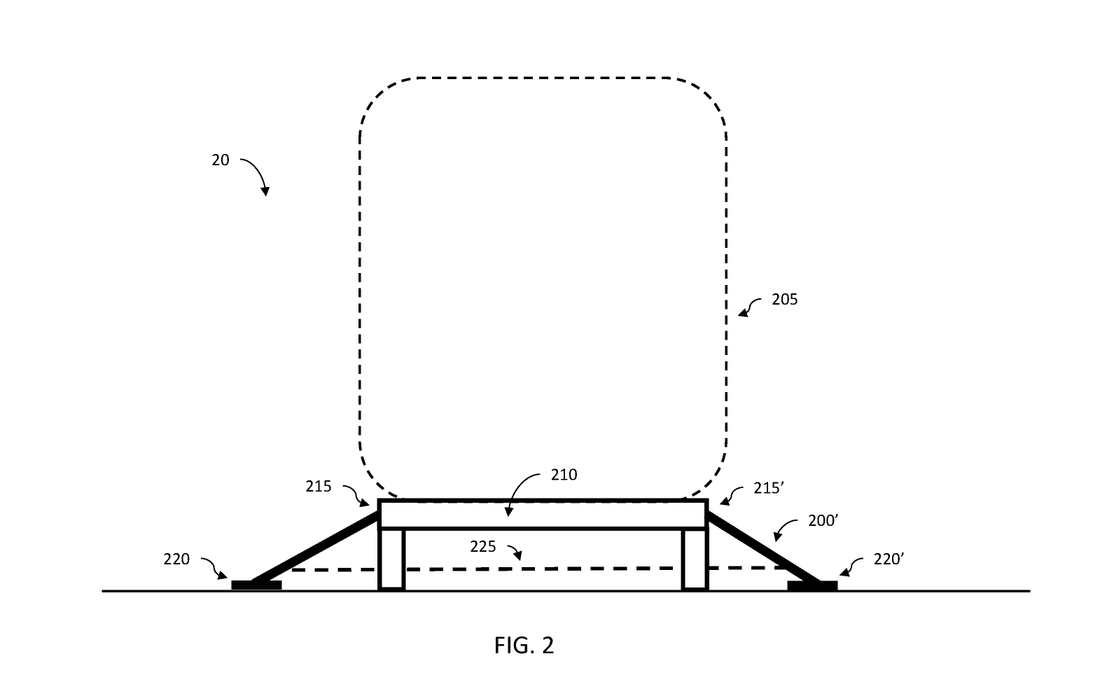

As depicted in FIG. 2, in an exemplary embodiment of the inventive trailer or recreational vehicle stabilizer (20), at least two laterally opposing diagonally extending legs or struts (200, 200′) are affixed to a trailer or vehicle (205), preferably to a or the ridged frame (210) of the trailer or vehicle, and most preferably affixed to a portion of the frame (215, 215′) in proximity to any existing or integrated support or leveling system.

It is contemplated that the at least two legs or struts (200, 200′) may be adjustable in length and capable of being stowed and secured for or during trailer or vehicle travel, and deployable as required once the trailer or vehicle is stationary and/or leveled.

It is contemplated that the at least two legs or struts (200, 200′) are adjustable and fixable in length by known mechanical systems such as but not limited to, telescoping nested tubes secured by perpendicular openings and traversing locking pin, or by a threaded collar releasably capable of fixing the length of leg or strut by tension and/or frictional force.

It is contemplated that the at least two legs or struts (200, 200′) include “foot pads” (220, 220′) proximal to the leg or strut frame fixation points (215, 215′) to provide more contact area on a surface or the ground. It is also contemplated that the foot pads (220, 220′) may swivel in a single or multiple axis to establish and maintain full contact on an angled or uneven surface or ground.

It is contemplated that the at least two legs or struts (200, 200′) may be affixed to the ridged frame (210) of the trailer or vehicle by known mechanical systems such as but not limited to: eye bolt, bushing, and traversing opening, or by a ball and socket joint.

It is contemplated that the at least two legs or struts (200, 200′), regardless of the fixation system utilized, allows for the deployment and/or adjustment of the at least two legs or struts (200, 200′), and once deployed and/or adjusted rigidly transfers static vector mechanical forces from a surface or the ground to the trailer or vehicle frame (210) to mitigate or prevent lateral rocking of the trailer or vehicle (205).

It is contemplated that the single chain or cable (225) once affixed or connected to the at least two legs or struts (200, 200′) is capable of having its length to be shortened to exert equilateral tension between the at two legs or struts (200, 200′), and thereby exert and maintain a downward force at the leg or strut ends when impacting a surface or the ground.

It is contemplated that the single chain or cable (225) may be adjusted in length via a “come along” winch, threaded turnbuckle, or by other similar or by known mechanical system capable of shorting the length of the single chain or cable (225) to exert equilateral tension between the at two legs or struts (200, 200′).

One dynamic theory of operation of the present embodiment may be as follows: Once a trailer or vehicle is stationary and if desired leveled via a support and/or leveling system, the at least two legs and struts (200, 200′) are deployed to rest upon a surface or the ground. Next the single chain or cable (225) is affixed or connected to the at least two legs or struts (200, 200′) and shorted by mechanical system (not shown) to exert equilateral tension between the at two legs or struts (200, 200′) which “scissors” the at least two legs or struts (200, 200′) which exerts a downward force to the proximal “foot pads” (220, 220′) thus improving the lateral stability of the trailer or vehicle (205).

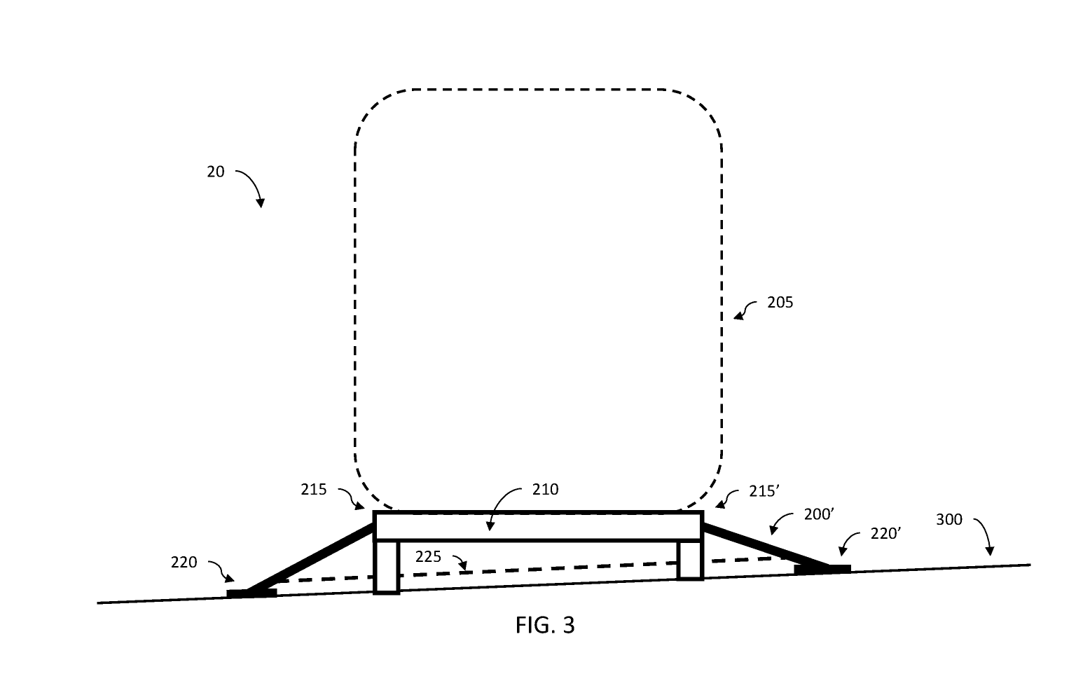

Referencing FIG. 3, another dynamic theory of operation of the present embodiment, when utilized on a pronounced uneven surface or ground (300), may be as follows: Once a trailer or vehicle is stationary and leveled via a support and/or leveling system, the at least two legs and struts (200, 200′) are deployed to rest upon the uneven surface or the ground. Depending on the unevenness on the location of stabilizer deployment, the at least two legs or struts (200, 200′) may be adjusted to a desired or required length to come to rest on the uneven surface or ground. Next the single chain or cable (225) is affixed or connected to the at least two legs or struts (200, 200′) and shorted by mechanical system (not shown) to exert equilateral tension between the at two legs or struts (200, 200′) which “scissors” the at least two legs or struts (200, 200′) which exerts a downward force to the proximal “foot pads” (220, 220′) thus improving the lateral stability of the trailer or vehicle (205).

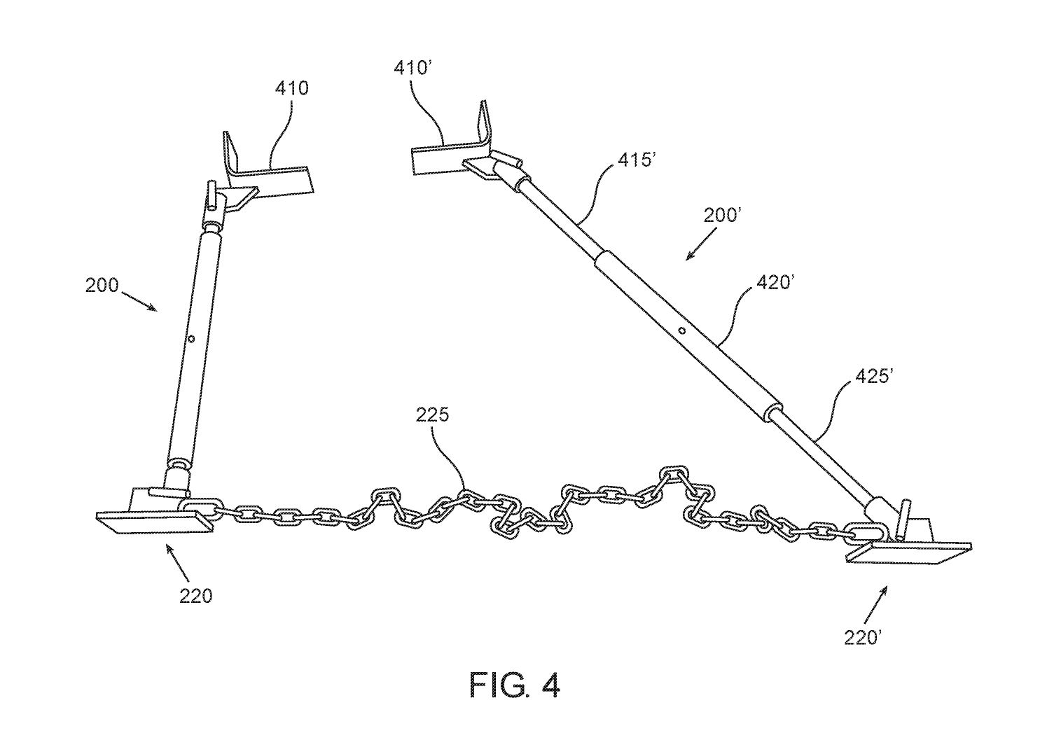

Referring to FIGS. 4-6, perspective views of an embodiment of the inventive system are shown.

FIG. 4 shows the inventive system having the single chain or cable (225) is affixed or connected to the at least two legs or struts (200, 200′). The two legs or struts (200, 200′) are shown having lengths that are extendable and being made of top portion 415′, middle portion 420′ and bottom portion 425′. The legs are connected to “foot pads” (220, 220′) and also to connection elements (410, 410′) which are connected to a recreational vehicle. The “foot pads” improve the lateral stability of the trailer. The connection elements or stabilizers are screwed into the chassis of a trailer via a simple tightening method. When the connection elements are screwed, the chain has great force and downward pressure so as to prevent rocking of the trailer when users are moving about the trailer.

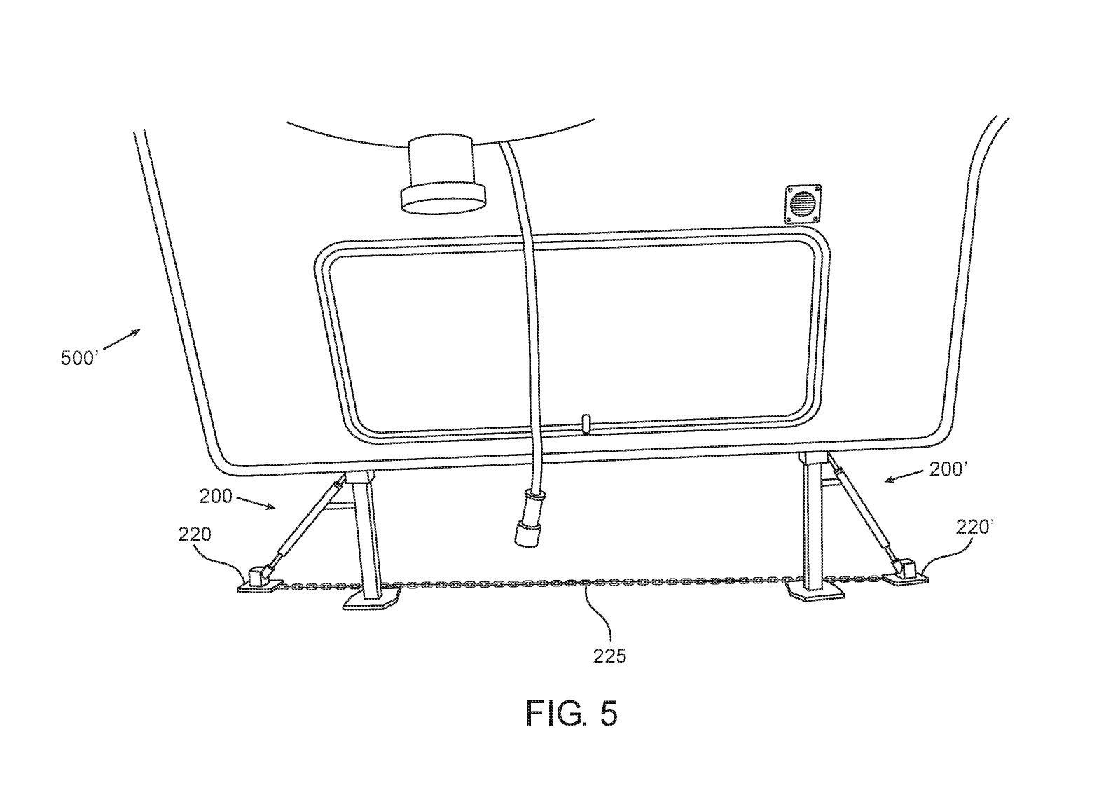

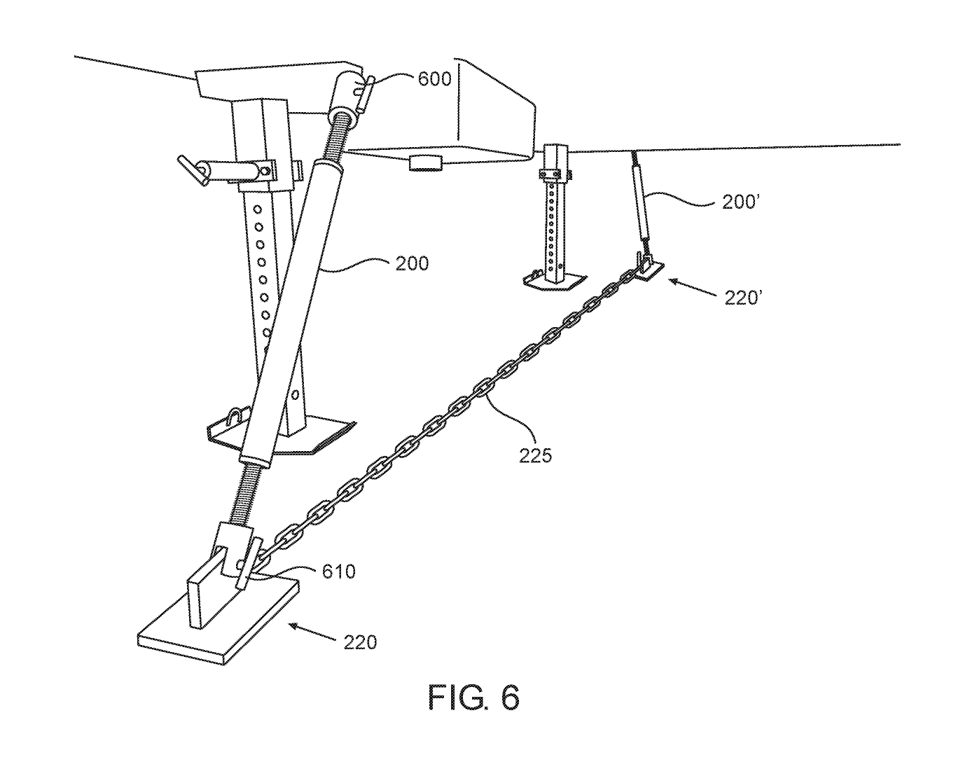

FIGS. 5-6 are perspective views of the system employed upon a recreational vehicle. FIG. 5 shows the system employed in a manner whereby the single chain or cable (225) is affixed or connected to the at least two legs or struts (200, 200′) and the chain has great force and downward pressure so as to prevent rocking of the trailer when users are moving about the trailer

FIG. 6 shows the system having the single chain or cable (225) is affixed or connected to the at least two legs or struts (200, 200′). The upper portion of the system 600 is shown connected to the chassis of a recreational vehicle and has the ability to be tightened to secure the system to the recreational vehicle.

The invention is designed to mount onto any trailer and is handy, easy to operate and has very few moving parts. The design works together as one unit and creates force or pressure by having an outward force on the chain, downward force on the pads and upward and inward force onto the frame or chassis of the trailer. The device can be screwed so as to be enough to lift the trailer and creates tremendous force up and inward onto the frame (which is the most solid thing on the trailer). The amount of force prevents the trailer from rocking and keeps it stable.

In a certain preferred embodiment, the device is made from the following components:

4 1½″ diameter tube×14″ long with threaded caps;

4 ¾-10 LH threaded rod×8″ long

4 ¾-10 RH threaded rod×8″ long

4 ⅜×4×5 plates

4 ½×1 ½×3 with a ¼ hole for pin mounted to plate

4 ½×2 ½×3 with a ¼ hole for pin mounted to angle iron

4 ¼×3 ½×5 angle iron

2 ¼×10 ft. chain.

In certain embodiments, the legs are each screwed to the 4 corners of the trailer and each of the legs provides an upward and inwards pressure to stabilize the trailer.

In certain embodiments, the method involves using hand tightening to engage the legs and connections to the recreational vehicle.

In certain embodiments, a simple hand tightening will be sufficient.

Having thus described several embodiments for practicing the inventive method, its advantages and objectives can be easily understood. Variations from the description above may and can be made by one skilled in the art without departing from the scope of the invention.

Accordingly, this invention is not to be limited by the embodiments as described, which are given by way of example only and not by way of limitation.

What is claimed is:

1. A system of and for stabilizing a recreational vehicle (RV), the system comprising:
at least two laterally opposing diagonally extending legs or struts proximally affixed to the recreational vehicle frame; and
a single chain or cable connecting the legs or struts;
wherein when the legs or struts distally impact a surface and/or the ground the legs or struts transfer vector mechanical forces from the surface and/or the ground to the recreational vehicle frame to mitigate or prevent lateral rocking movement of the recreational vehicle.

2. The system of claim 1, wherein the recreational vehicle is selected from a group consisting of a stationary trailer, trailer home, house trailer, static caravan, residential caravan, modular home, vehicle capable of being towed or on a trailer, and prefabricated structure.

3. The system of claim 1 wherein at least one of the at least two legs or struts includes a distally mounted foot pad.

4. The system of claim 1, wherein the single chain or cable exerts equilateral tension on the legs or struts.

5. The system of claim 1, wherein the at least two legs or struts are affixed to the recreational vehicle frame by mechanical systems from the group consisting of eye bolts, bushings, traversing openings with bolt and nut, ball and socket joints, and combinations thereof.

6. The system of claim 1, wherein the single chain or cable length is adjustable and fixable.

7. The system of claim 1, wherein the single chain or cable length is adjustable and fixable under tension.

8. The system of claim 1, wherein the single chain or cable ends are connected at a distally mounted foot pad of at least one of the at least two legs or struts.

9. The system of claim 1, wherein the single chain or cable ends are connected at the at least two leg or strut distal ends.

10. The system of claim 1, wherein the at least two legs or struts are of differing lengths.

11. The system of claim 1, wherein the at least two legs or struts are adjustable and fixable in length via mechanical systems from the group consisting of telescoping nested tubes secured by perpendicular traversing openings and pins, releasable threaded, tension, or friction collars, and combinations thereof.

12. The system of claim 1, wherein the single chain or cable length is adjusted and fixed via mechanical systems from the group consisting of turnbuckles, come-alongs, manual-winches, electric-winches, and combinations thereof.

13. The system of claim 1, wherein the system is capable of chain or cable tension adjustment after the legs or struts are deployed on an uneven surface or uneven ground.

14. The system of claim 1, wherein the system includes at least four legs or struts.

15. The system of claim 1, wherein the system is capable of being removed and/or stowed to allow for road worthy recreational vehicle movement and/or towing.

16. A system of and for stabilizing a recreational vehicle, the system comprising:
at least two laterally opposing diagonally extending legs or struts proximally affixed to the recreational vehicle chassis or frame, the legs or struts connected with a single chain or cable to exert tension between the legs or struts;
wherein when the legs or struts distally impact a surface and/or the ground transfers to mitigate or prevent lateral rocking movement of the recreational vehicle.

17. A method of and for stabilizing a stationary recreational vehicle, the method comprising:
providing at least two laterally opposing diagonally extending legs or struts;
affixing the proximal end of the at least two legs or struts to the recreational vehicle frame;
providing a single chain or cable; and
connecting the single chain or cable to the at least two legs or struts to exert equilateral tension between the at least two legs or struts;
wherein when the legs or struts distally impact a surface and/or the ground the legs or struts transfer vector mechanical forces from the surface and/or the ground to the recreational vehicle frame to mitigate or prevent lateral rocking movement of the recreational vehicle.
